(19) United States
(12) Patent Application Publication
(10) Pub. No.: US 2003/0237073 A1
(43) Pub. Date: Dec. 25, 2003

(54) Software synchronization of interface and class implementation

(76) Inventors: Karel Gardas, Roznov pod Radhostem (CZ); Tomas Zezula, Novy Malin (CZ); Dusan Balek, Bukova (CZ)

Correspondence Address: ROSENTHAL & OSHA L.L.P. / SUN, 1221 MCKINNEY, SUITE 2800, HOUSTON, TX, 77010, US

(21) Appl. No.: 09/860,013

(22) Filed: May 17, 2001

(51) Int. Cl. G06F 9/44

(52) U.S. Cl. 717/116; 717/100

(57) ABSTRACT

A method of synchronization of an interface and a class implementation in accordance with the present invention includes generating the class implementation from the provided interface onto a memory element and examining a storage device to determine whether the class implementation exists. A computer system in accordance with the present invention is adapted to synchronize an interface and a class implementation includes a processor and a memory element, including software instructions; wherein the software instructions are adapted to enable the computer under control of the processor, to perform standard synchronization of the interface and the class implementation as part of an implementation generation component of a support module for an integrated development environment. A support module for an integrated development environment in accordance with the present invention includes an editor component for writing an interface file, an interface compiler component that compiles the interface file into constructs in a target computer language, an implementation generator component that generates an implementation for all interfaces from the interface file, and a synchronization portion of the implementation generator component that updates the implementation with modifications to the interface file.

### BACKGROUND OF INVENTION

1. Field of the Invention

This invention relates to the field of software development tools for developing distributed object applications.

2. Background Art

Applications developed using distributed objects such as Common Object Request Broker Architecture (CORBA) naturally lend themselves to multi-tiered architecture, fostering a neat separation of functionality. A three-tiered application has a user interface code tier, a computation code (or business logic) tier, and a database access tier. All interactions between the tiers occur via the interfaces that all CORBA objects publish. FIG. 1 illustrates the transition from monolithic applications to multi-tiered, modular applications. A first generation system (2) has a graphical user interface (GUI) (8), a business logic (10), and a data store (12) all combined into one monolithic application. A next generation system (4) has the GUI (8) and the business logic (10) as one application with an interface to the data store (12). A latest generation system (6) has three distinct tiers. A first tier or user interface (UI) tier (20) includes one or more GUI (8), which interface with one or more service logic (13) in a second tier or service tier (22). The service logic (13) in the service tier (22) interfaces with other service logic (13), one or more GUI (8), and one or more data sources (14). A third tier or data store tier (24) includes one or more data sources (14), which interface with one or more service logic (13).

The UI tier is the layer of user interaction. The focus is on efficient user interface design and accessibility. The UI tier can reside on a user desktop, on an Intranet, or on the Internet. Multiple implementations of the UI tier may be deployed accessing the same server. The UI tier usually invokes methods on the service tier and, therefore, acts as a client. The service tier is server-based code with which client code interacts. The service tier is made up of business objects (CORBA objects that perform logical business functions, such as inventory control, budget, sales order, and billing). These objects usually invoke methods on the data store tier objects. The data store tier is made up of objects that encapsulate database routines and interact directly with the database management system product or products.

CORBA is the standard distributed object architecture developed by an Object Management Group (OMG) consortium. The mission of the OMG is to create a specification of architecture for an open software bus, or Object Request Broker (ORB), on which object components written by different vendors can interoperate across networks and operation systems.

The ORB is middleware that establishes the client-server relationships between objects by interacting and making requests to differing objects. The ORB sits between distributed (CORBA) objects in the second tier of the three tier architecture and operates as a class library enabling low-level communication between parts (objects) of CORBA applications. Programmers usually write applications logic in CORBA and the application logic is then connected to the data store by using some other application, e.g., ODBC, JDBC, proprietary, etc. Usually only objects in the application logic communicate using the ORB. Using the ORB, a client transparently invokes a method on a server object, which can be on the same machine or across a network. The ORB intercepts a call and is responsible for finding an object that can implement a request, pass the object a plurality of parameters, invoke the method, and return the results. The client does not have to be aware where the object is located, the programming language of the object, the operating system of the object, or any other system aspects that are not part of the interface of the object. In other words, the application logic can be run on many hosts in many operating systems and parts of the application logic can be written in different computer languages.

The diagram, shown in FIG. 2, shows a method request (30) sent from a client (32) to an instance of a CORBA object implementation, e.g., servant (36) (the actual code and data that implements the CORBA object) in a server (34). The client (32) is any code that invokes a method on the CORBA object. The client (32) of the CORBA object has an object reference (38) for the object and the client (32) uses this object reference (38) to issue method request (30). If the server object (36) is remote, the object reference (38) points to a stub function (40), which uses the ORB machinery (42) to forward invocations to the server object (36). The stub function (40) encapsulates the actual object reference (38), providing what seems like a direct interface to the remote object in the local environment. The stub function (40) uses the ORB (42) to identify the machine that runs the server object and, in turn, asks for that machine's ORB (44) for a connection to the object's server (34). When the stub function (40) has the connection, the stub function (40) sends the object reference (38) and parameters to the skeleton code (46) linked to an implementation of a destination object. The skeleton code (46) transforms the object reference (38) and parameters into the required implementation-specific format and calls the object. Any results or exceptions are returned along the same path.

The client (32) has no knowledge of the location of the CORBA object, implementation details of the CORBA object, or which ORB (44) is used to access the CORBA object. A client ORB (44) and a server ORB (42) communicate via the OMG-specified Internet InterORB Protocol (IIOP) (48). The client (32) may only invoke methods that are specified in the interface of the CORBA object. The interface of the CORBA object is defined using the OMG IDL. CORBA objects can be written in any programming language for which there is mapping from IDL to that language (e.g., Java™, C++, C, Smalltalk, COBOL, and ADA). The IDL defines an object type and specifies a set of named methods and parameters, as well as the exception types that these methods may return. An IDL compiler translates the CORBA object's interface into a specific programming language according to an appropriate OMG language mapping.

Referring to FIG. 2, the stub files (40) and skeleton files (46) are generated by an IDL compiler for each object type. Stub files (40) present the client (32) with access to IDL-defined methods in the client programming language. The server skeleton files (46) figuratively glue the object implementation to the ORB (44) runtime. The ORB (44) uses the skeletons (46) to dispatch methods to the servants (36).

All CORBA objects support an IDL interface. The IDL interface defines an object type and can inherit from one or more other interfaces. The IDL syntax is very similar to that of Java™ or C++. The IDL is mapped into each programming language to provide access to object interfaces from that particular language. Using an IDL compiler of a CORBA implementation for Java™, the IDL interfaces are translated to Java constructs according to IDL to Java™ language mapping. For each IDL interface, IDL compiler generates a Java™ interface, classes, and other Θ.java” files needed, including the stub files and the skeleton files.

As a general guide, creating a CORBA-based distributed application has five steps as shown in FIG. 3. The first step is to define a remote interface (Step 50). The interface is defined using the IDL. Also, by using the IDL, the possibility exists to implement clients and servers in any other CORBA-compliant language. If the client is being implemented for an existing CORBA service, or the server for an existing client, the IDL interfaces come from the implementer, e.g., a service provider or vendor. The IDL compiler is then run over those interfaces.

Referring to FIG. 3, the second step is to compile the remote interface (Step 52). When the IDL compiler is run over the interface definition file, the Java™ version of the interface is generated along with class code files for the stubs and skeletons that enable applications to hook into the ORB.

The third step is to implement the server (Step 54). Once the IDL compiler is run, the skeletons generated by the compiler are used to put together the server application. In addition to implementing the methods of the remote interface, the server code includes a mechanism to start the ORB and wait for invocation from a remote client.

The fourth step is to implement the client (Step 56) as shown in FIG. 3. Similarly to the implementation of the server, the stubs generated by the IDL compiler are used as the basis of the client application. The client code builds on the stubs to start the ORB, obtain a reference for the remote object, and call the method.

The fifth step is to start the application (Step 58). Once the server and client have been implemented and the server is started, the client is run.

As illustrated in FIG. 4, Forte™ for Java™ products (90), formerly called NetBeans, are visual programming environments written entirely in Java™. These products are commonly regarded as the leading Integrated Development Environment (IDE). IDEs are easily customizable and extensible, as well as platform independent. Forte™ for Java™ (90) includes a Form Editor (92), an integrated full-featured text editor (94), a debugger (98), and a compiler (100). Forte™ for Java™ (90) is also completely modular. Forte™ for Java™ (90) is built around a set of Open Application Programming Interface (API's) which allow it to be easily extensible. This means that the IDE functionality for editing, debugging, GUI generation, etc. is represented in modules that can be downloaded and updated dynamically as is illustrated in FIG. 4. Instead of waiting for a completely new release, as soon as new versions (104) or new modules (106) are available, users can update that individual version or module via the Update Center (102).

### SUMMARY OF INVENTION

In general, in one aspect, the present invention involves a method of synchronization of an interface and a class implementation, comprising generating the class implementation from the provided interface onto a memory element, and examining a storage device to determine whether the class implementation exists.

In general, in one aspect, the present invention involves a system providing synchronization of an interface and a class implementation comprising means for generating the class implementation from the provided interface onto a memory element, and means for examining a storage device to determine whether the class implementation exists.

In general, in one aspect, the present invention involves a computer system adapted to synchronize an interface and a class implementation, comprising a processor, a memory element and software instructions. The software instructions are for enabling the computer under control of the processor, to perform standard synchronization of the interface and the class implementation as part of an implementation generation component of a support module for an integrated development environment.

In general, in one aspect, the present invention involves a support module for an integrated development environment, comprising an editor component for writing an interface file, an interface compiler component that compiles the interface file into constructs in a target computer language, an implementation generator component that generates an implementation for all interfaces from the interface file, and a synchronization portion of the implementation generator component that updates the implementation with modifications to the interface file.

Other aspects and advantages of the invention will be apparent from the following description and the appended claims.

### BRIEF DESCRIPTION OF DRAWINGS

FIG. 1 illustrates the transition from monolithic applications to multi-tiered, modular applications.

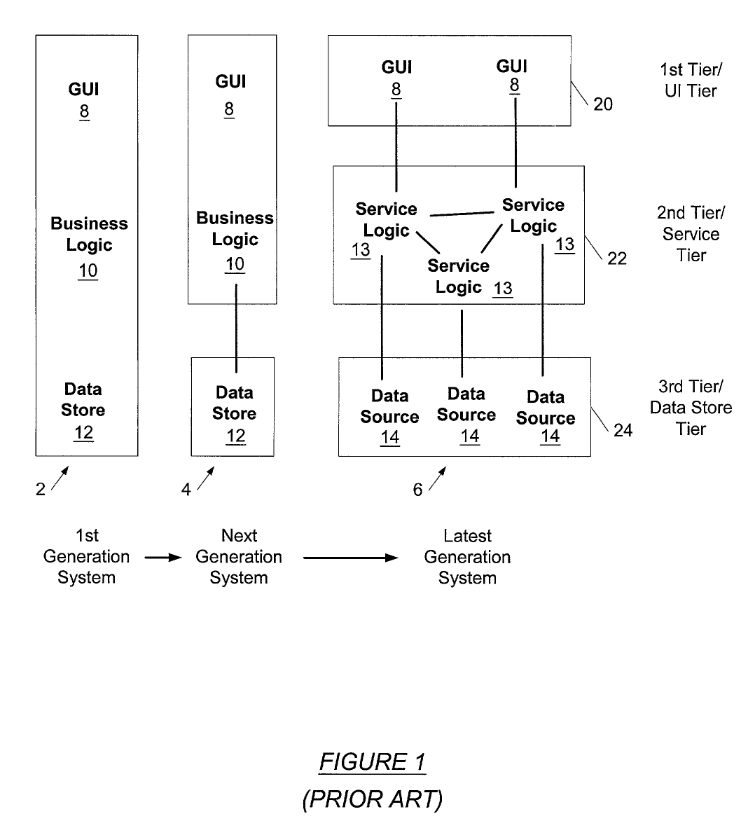

FIG. 2 illustrates a method request sent from a client to a CORBA object implementation in a server.

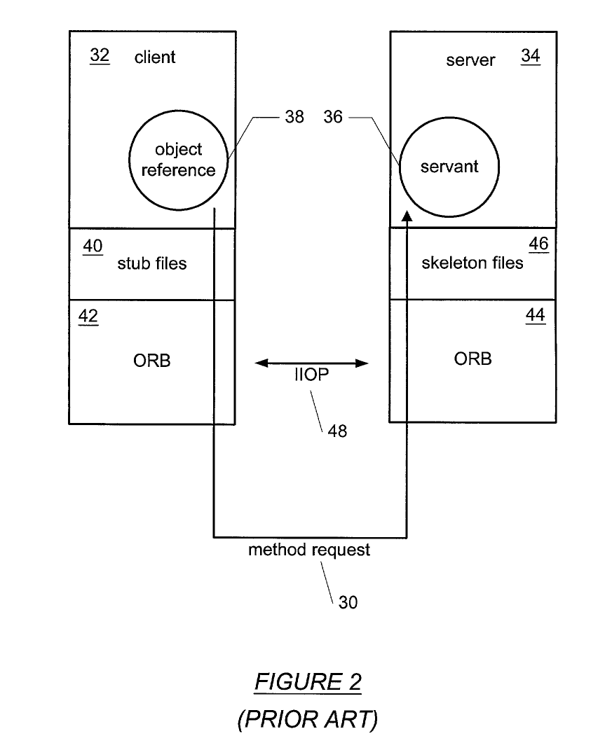

FIG. 3 illustrates a flowchart of the creation of a distributed object application using CORBA implementation.

FIG. 4 illustrates a Forte™ for Java™ Integrated Development Environment (IDE).

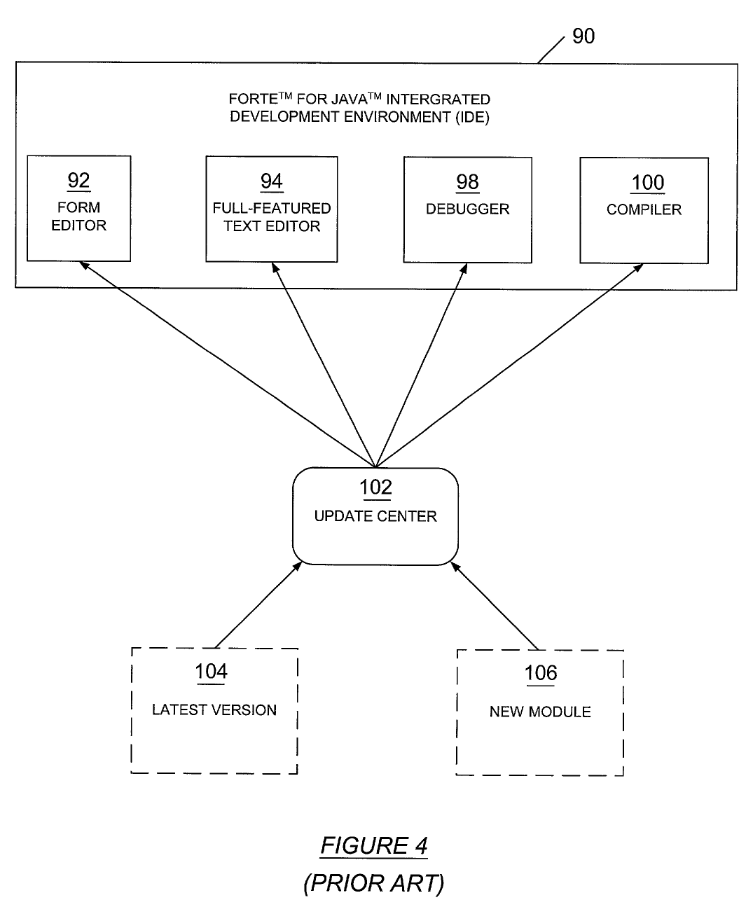

FIG. 5 illustrates a typical computer and its components.

FIG. 6 illustrates a CORBA support module for an IDE in accordance with one or more embodiments of the present invention.

FIG. 7 illustrates a computer screen shot of the Explorer dialog box within Forte™ for Java™ IDE in accordance with one or more embodiments of the present invention.

FIG. 8 illustrates a computer screen shot of the Source Editor dialog box within Forte™ for Java™ IDE in accordance with one or more embodiments of the present invention.

FIG. 9 illustrates a computer screen shot of the Source Editor dialog box within Forte™ for Java™ IDE in accordance with one or more embodiments of the present invention.

FIG. 10 illustrates a computer screen shot of the Explorer dialog box within Forte™ for Java™ IDE in accordance with one or more embodiments of the present invention.

FIG. 11 illustrates a computer screen shot of the synchronization dialog box within the CORBA Support Module of Forte™ for Java™ IDE in accordance with one or more embodiments of the present invention.

FIG. 12 illustrates a flowchart of the method of synchronization of interface and implementation.

### DETAILED DESCRIPTION

Specific embodiments of the invention will now be described in detail with reference to the accompanying figures. Like elements in the various figures are denoted by like reference numerals for consistency.

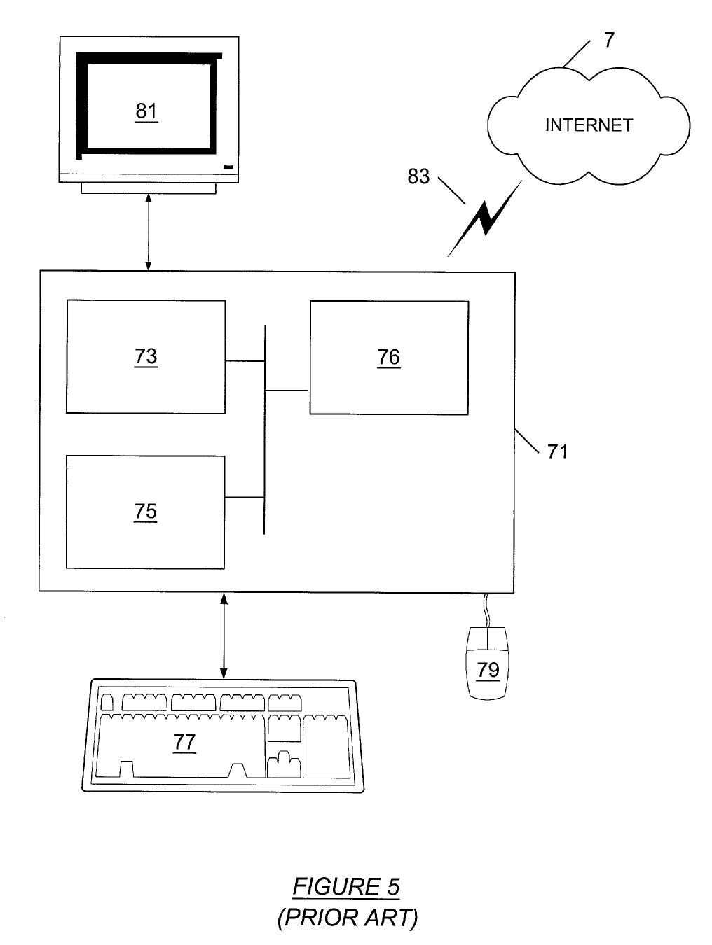

The invention described here may be implemented on virtually any type computer regardless of the platform being used. For example, as shown in FIG. 5, a typical computer (71) includes a processor (73), an associated memory element (75), a storage device (76), and numerous other elements and functionalities typical to today's computers (not shown). The computer (71) may also include input means, such as a keyboard (77) and a mouse (79), and an output device, such as a monitor (81). Those skilled in the art will appreciate that these input and output means may take other forms. Computer (71) is connected via a network connection (83) to the Internet (7).

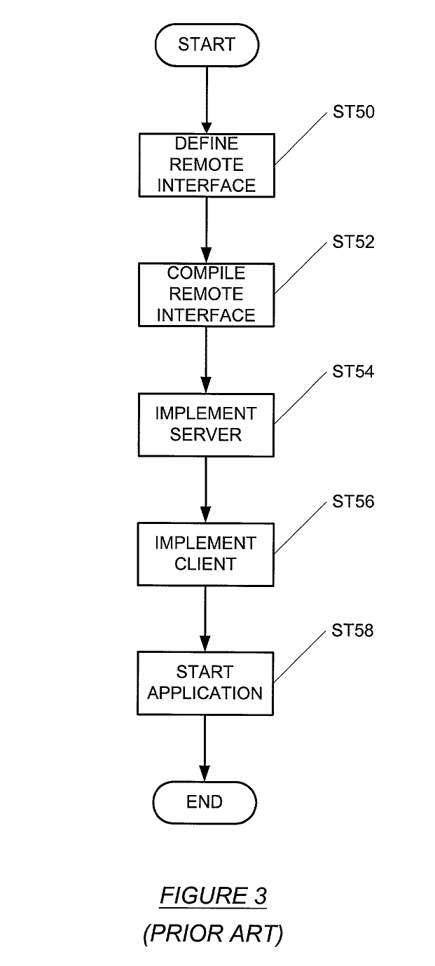

The present invention helps developers with the synchronization of the IDL interface(s) and Java™ implementation(s). As discussed above and shown in FIG. 3, development of CORBA object applications starts with a developer defining remote interface(s) (Step 50) of CORBA server objects using the IDL which is part of the CORBA specification. Next, the description of interface(s) is compiled using the IDL compiler (Step 52) into constructs in a target computer language. Mapping of the IDL constructs into constructs in the target language is specified by the CORBA specification. In the case of the CORBA implementation written in Java™, these constructs are classes in Java™ and provide all necessary functionality for communicating over the ORB. The third and fourth steps in writing the CORBA application is writing implementation of defined interface(s) for the server (Step 54) and the client (Step 56). Writing the implementation is done in the target language and usually extends constructs produced by the IDL compiler. CORBA implementation written in Java™ requires the implementation be written with a new class for every interface which extends or implements some generated class. In other words, any time the developer changes the specification of interface(s) of the server object(s) in the IDL interface, the developer is required to change the implementation of the objects as well.

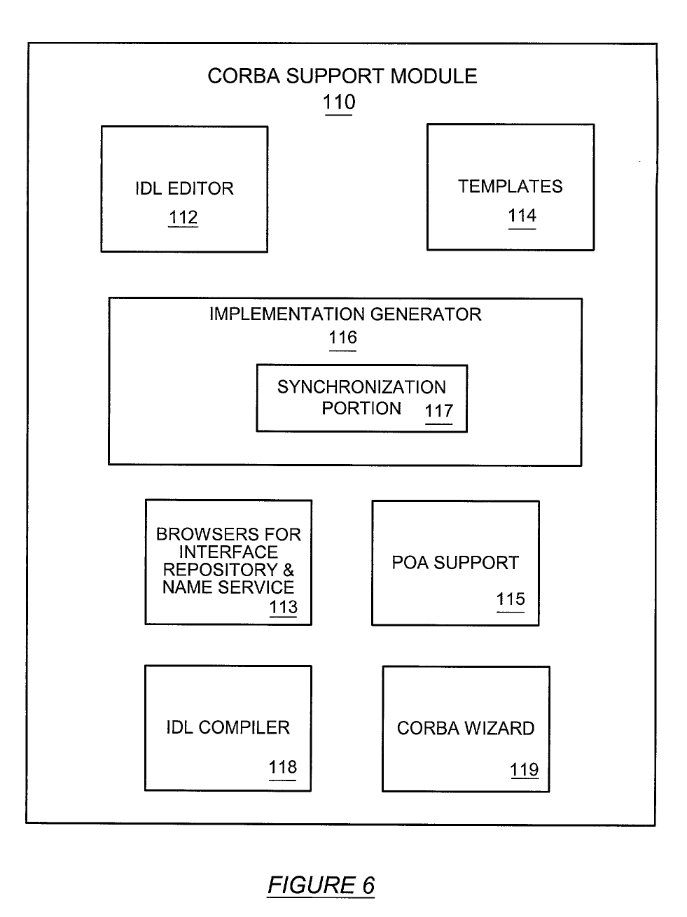

Returning to the Forte™ for Java™ IDE, a CORBA support module (110) as shown in FIG. 6 has been created to be used within Forte™ for Java™ or any other IDE to develop, test, and debug any kind of CORBA application. The CORBA support module (110) provides support for writing the IDL file in an editor (112) or generating the IDL file from various templates (114). The IDL file is then compiled using an IDL Compiler (118) into constructs in a target computer language, such as classes in Java™. The support module (110) also provides support for editing or generating client and server main and implementation classes. Further, the CORBA support module (110) includes browsers for interface repository and name service (113), a POA support component (115), and a CORBA wizard component (119).

An important part of the CORBA support module (110) of the Forte™ for Java™ IDE is an Implementation Generator (116). After writing the IDL file, the developer implements all interfaces that are written to the IDL file. The support module (110) assists the developer with this task through the medium of the Implementation Generator (116). Using the Implementation Generator (116), the developer can generate a basic implementation (i.e., an implementation with empty method body) for all interfaces from the IDL file. During the generation of the implementation, customizable options are available of certain setup properties (e.g., generation of method bodies, etc.)

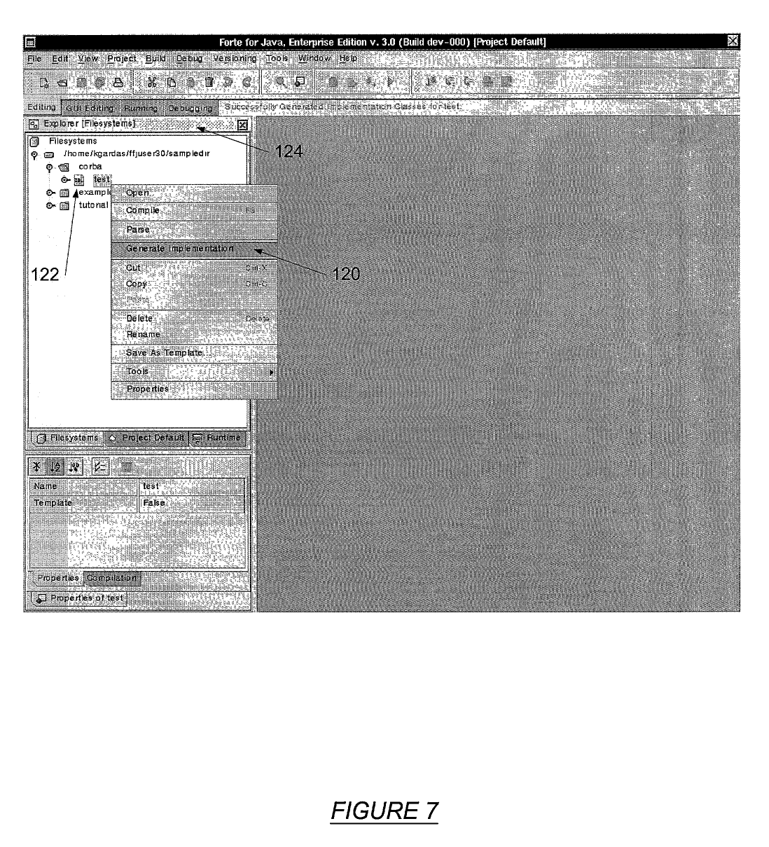

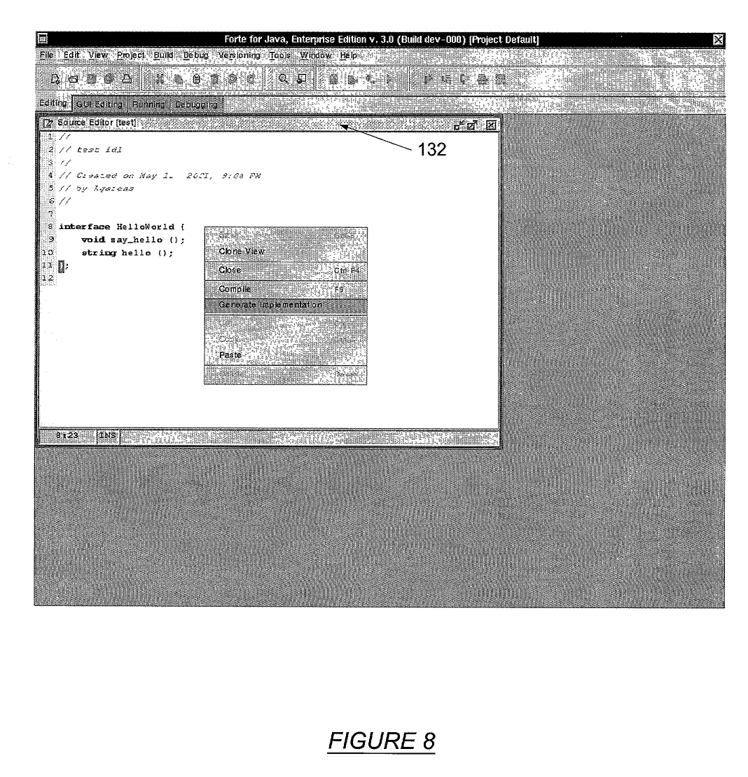

The Implementation Generator is activated either by selecting the “Generate Implementation” menu item (120) in a standard pop-up menu from within the IDL Node (122) in the Explorer (124) as shown in FIG. 7, or by selecting the Generate Implementation menu item in a standard pop-up menu in the a source editor (132) as shown in FIG. 8. The result is source code in the source editor within the IDE in Java™ language.

Often, the developer needs to change the IDL interfaces (or other structures) in the application. When the developer changes the IDL interface, the same changes need to be applied to the implementation. This process would be a completely manual process with a high potential for errors, which could result in many “bugs” in the application; however, as shown in FIG. 6, the CORBA support module (110) provides an automated way to update the implementation using the synchronization portion (117) of the Implementation Generator (116).

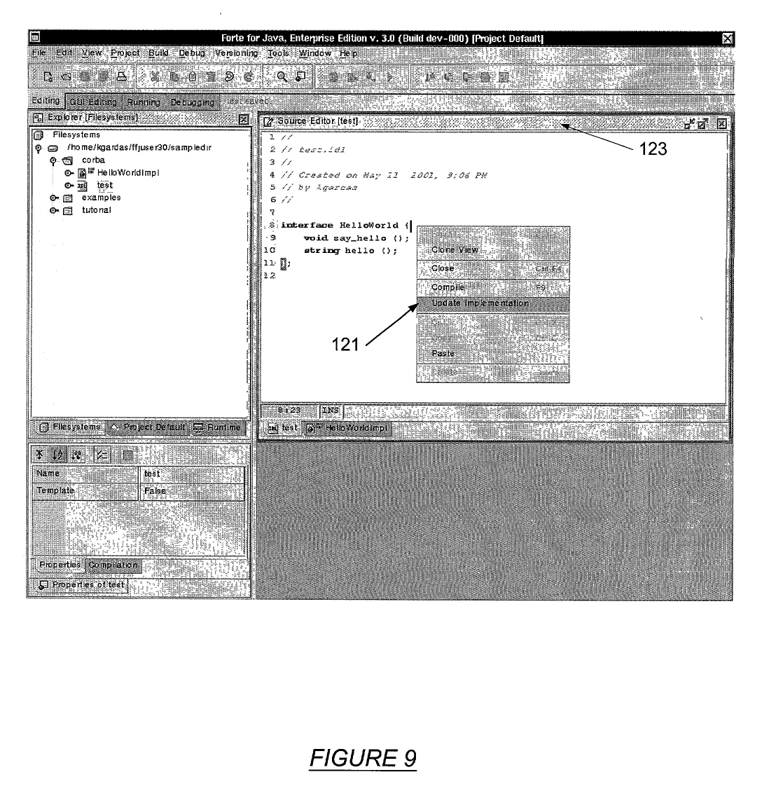

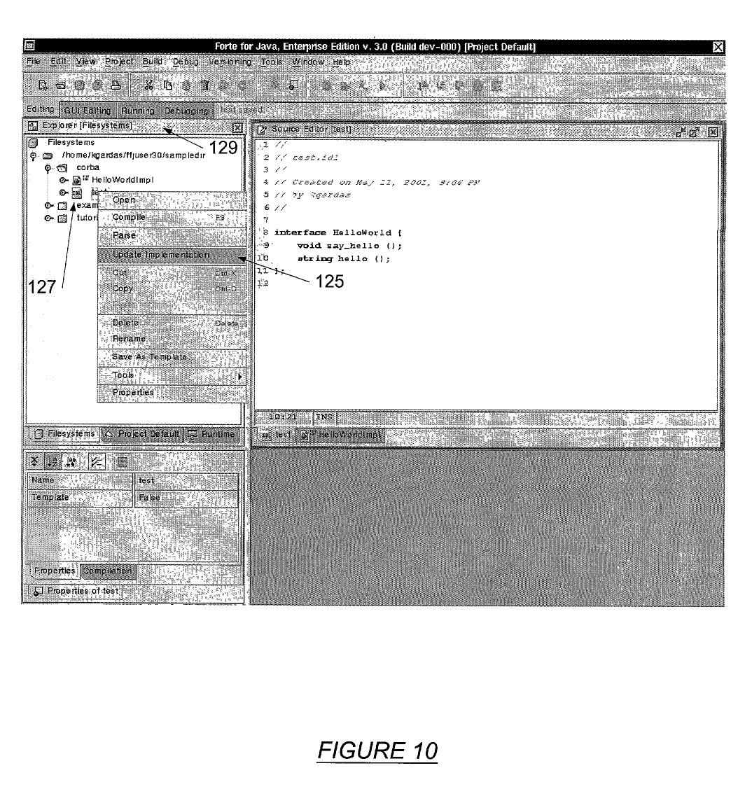

When the developer adds new interfaces, adds a new operations, adds a new operation parameters, or changes an operation name in an existing interfaces to the IDL file, the developer can use the Update Implementation (or Update and Generate Implementation) functions. The functions are activated by selecting the “Update Implementation” (or “Update and Generate Implementation”) menu item (121) in a standard pop-up menu in the Editor (123) as shown in FIG. 9 or select the menu item (125) from within the IDL node (127) in the Explorer (129) as shown in FIG. 10. The CORBA support module automatically generates a new implementation for all added interfaces and modifies the implementation of the modified interface(s), e.g., added or changed operation(s).

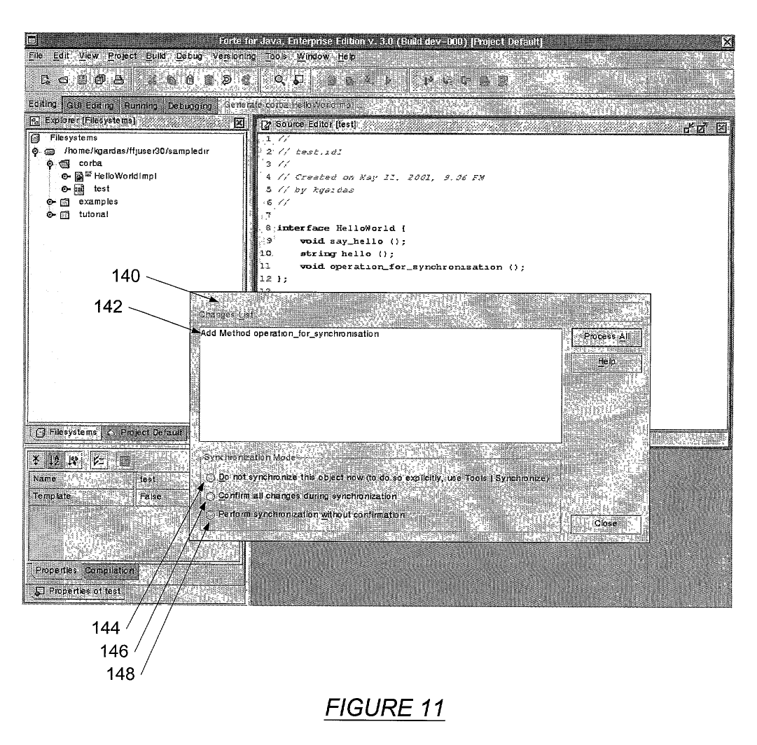

Synchronization is heavily used in updating the implementation. For example, the developer modifies the interface and then updates the implementation using the standard action Update Implementation. Next, a Java™ Synchronization dialog box (140) as shown in FIG. 11 appears and the developer selects which methods (142) to add to the implementation. The dialog box (140) also provides the developer with a choice of synchronization modes. Using these synchronization modes, the developer can choose not to synchronize (144) or can choose to automatically synchronize with confirmation sought for each change (146) or without confirmation (148).

The Implementation Generator provides functionality to generate a complete implementation from a selected IDL. The CORBA support module as part of the IDE provides synchronization from the IDL interface to Java™ Implementations that is built on top of Implementation Generator. To perform the generation of the implementation from the IDL interface(s), the Implementation Generator, uses standard Open API and “source hierarchy” for constructing Java™ classes. The same Open API is also used for synchronization between the two Java™ classes.

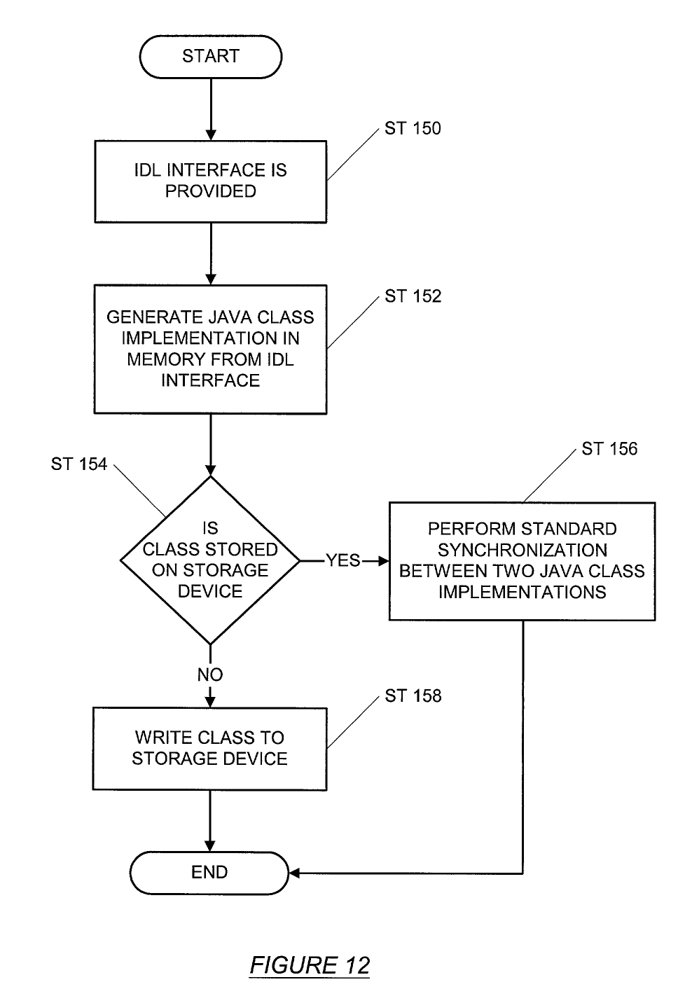

Referring to FIG. 12, the method of synchronization of the IDL interface and the Java™ class implementation starts when an IDL interface is provided (Step 150). Next, a Java™ class implementation is generated onto a memory element from the provided IDL interface (Step 152). Then, class implementations stored on a storage device are examined to determine whether the class implementation exists (Step 154). If the class implementation exists, then standard synchronization between the two class implementations is performed (the one class implementation from the memory element and the one class implementation stored on the storage device) (Step 156). If the class implementation does not exist, the Java™ class is written to the storage device (Step 158).

Advantages of the present invention may include one or more of the following. Synchronization from the IDL interface to Java™ Implementations occurs using the standard Open API and the Implementation Generator using a method that generates Java™ classes onto the memory element for comparison purposes instead of onto the storage device. The time required to develop a distributed object application is reduced by automating the method of generating and synchronizing the implementation after modification of the IDL interface. The number of mistakes due to by manual synchronization of the implementations is reduced. Those skilled in the art will appreciate that the present invention may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of synchronization of an interface and a class implementation, comprising:
generating the class implementation from the provided interface onto a memory element; and
examining a storage device to determine whether the class implementation exists.

2. The method of claim 1, further comprising:
performing standard synchronization between a first class implementation generated onto the memory element and a second class implementation stored on the storage device based on whether the class implementation exists on the storage device.

3. The method of claim 1, further comprising
writing the class implementation to the storage device based on whether the class implementation does not exist on the storage device.

4. The method of claim 2, wherein standard synchronization is performed as part of an implementation generation component of a support module for an integrated development environment.

5. A system providing synchronization of an interface and a class implementation, comprising:
means for generating the class implementation from the provided interface onto a memory element; and
means for examining a storage device to determine whether the class implementation exists.

6. The system of claim 5, further comprising:
means for performing standard synchronization between a first class implementation generated onto the memory element and a second class implementation stored on the storage device based on whether the class implementation exists on the storage device.

7. The system of claim 5, further comprising
means for writing the class implementation to the storage device based on whether the class implementation does not exist on the storage device.

8. The system of claim 5, wherein standard synchronization is performed as part of an implementation generation component of a support module for an integrated development environment.

9. A computer system adapted to synchronize an interface and a class implementation, comprising:
a processor;
a memory element, and
software instructions for
enabling the computer under control of the processor, to perform standard synchronization of the interface and the class implementation as part of an implementation generation component of a support module for an integrated development environment.

10. A support module for an integrated development environment, comprising:
an editor component for writing an interface file;
an interface compiler component that compiles the interface file into constructs in a target computer language;
an implementation generator component that generates an implementation for all interfaces from the interface file; and
a synchronization portion of the implementation generator component that updates the implementation with modifications to the interface file.

11. The support module of claim 10, wherein the editor uses a plurality of templates to generate the interface file.

12. The support module of claim 10, wherein constructs are Java classes.

13. The support module of claim 10, wherein the interface file is modified by adding an operation.

14. The support module of claim 10, wherein the interface file is modified by modifying an operation.

15. The support module of claim 10, wherein the interface file is modified by removing an operation.

16. The support module of claim 10, wherein the support module provides support for editing and generating main and implementation classes.

17. The support module of claim 10, wherein the implementation generator component is activated by a menu item in the integrated development environment.

18. The support module of claim 10, wherein modifications are confirmed during synchronization.

19. The support module of claim 10, wherein synchronization is performed without confirmation of modification.
